(19) United States
(12) Patent Application Publication
(10) Pub. No.: US 2016/0090191 A1
(43) Pub. Date: Mar. 31, 2016

(54) MONITORING DEVICE FOR DIFFERENTIAL TRANSFORMER SENSORS IN AN AIRCRAFT AND METHOD

(71) Applicant: AIRBUS OPERATIONS GMBH, Hamburg (DE)

(72) Inventors: Jan Luecker, Hamburg (DE); Mike Galinski, Hamburg (DE)

(21) Appl. No.: 14/869,452

(22) Filed: Sep. 29, 2015

(30) Foreign Application Priority Data
Sep. 30, 2014 (DE) 10 2014 219 848.8

(51) Int. Cl. B64D 45/00; G01D 5/22; G01D 18/00

(52) U.S. Cl. CPC B64D 45/00; G01D 18/00; G01D 5/2291

(57) ABSTRACT

A monitoring device for differential transformer sensors in an aircraft includes a first sensor interface which can be coupled with a first differential transformer sensor, a second sensor interface which can be coupled with a second differential transformer sensor, a calculation apparatus which is coupled with the first sensor interface and the second sensor interface and is designed to detect and output first measurement values from a first differential transformer sensor which is coupled with the first sensor interface and second measurement values from a second differential transformer sensor which is coupled with the second sensor interface, and having a display device which is designed to display the detected first measurement values and the detected second measurement values separately or together.

### CROSS-REFERENCE TO RELATED APPLICATION

This application claims priority to DE 10 2014 219848.8 filed Sep. 30, 2014, the entire disclosure of which is incorporated by reference herein.

### TECHNICAL FIELD

The present disclosure relates to a monitoring device for differential transformer sensors in an aircraft and to a corresponding method for monitoring differential transformer sensors in an aircraft.

### BACKGROUND

Although any desired sensors can be used, the present disclosure and the problem addressed thereby are explained in greater detail in relation to differential transformer sensors in an aircraft.

Modern aircraft have a plurality of control surfaces which, in particular in fly-by-wire-controlled aircraft, are controlled by electric actuators. This means that the pilot does not receive any direct feedback relating to the movements of the control surfaces, e.g. via control cables on the control stick.

In a fly-by-wire-controlled aircraft and in a flight controlled by the autopilot, it is therefore necessary to compare the movement of the individual control surfaces, e.g. the ailerons, rudders, elevators or the like, with the values which are predetermined either by the pilot via the control stick or by the autopilot. This is necessary in particular in order to be able to detect malfunctions of the control surfaces and of the actuators which drive the control surfaces.

In order to be able to monitor the movement of the control surfaces, sensors are therefore used on the individual control surfaces, which sensors detect the position of the respective control surface. The values detected by the sensors for the positions of the control surfaces can subsequently be compared with the predetermined values, and a malfunction of a control surface can be identified in the event of a deviation of the positions detected by the respective sensor from the predetermined values.

In this case, differential transformer sensors, e.g. RVDT sensors or LVDT sensors, are conventionally used as sensors in aircraft since the sensors are very robust with respect to external disturbances and have a very simple construction.

If sensors are used so as to be able to detect the movement of the individual control surfaces, the error-free operation of the sensors used must be monitored. This is carried out for example according to the method of U.S. 2012/0209238 A1.

### SUMMARY

An idea of the present disclosure is to provide improved sensor monitoring for differential transformer sensors in an aircraft.

Accordingly, a monitoring device for differential transformer sensors in an aircraft is provided, comprising a first sensor interface which can be coupled with a first differential transformer sensor, a second sensor interface which can be coupled with a second differential transformer sensor, a calculation apparatus which is coupled with the first sensor interface and the second sensor interface and is designed to detect and output first measurement values from a first differential transformer sensor which is coupled with the first sensor interface and second measurement values from a second differential transformer sensor which is coupled with the second sensor interface, and a display device which is designed to display the detected first measurement values and the detected second measurement values separately or together.

Furthermore, a method for monitoring differential transformer sensors in an aircraft is provided, comprising detecting first measurement values from a first differential transformer sensor; detecting second measurement values from a second differential transformer sensor, outputting the detected first measurement values and the detected second measurement values together by a first communication interface, and displaying the detected first measurement values and detected second measurement values which are output together by the first communication interface.

A concept on which the present disclosure is based comprises providing an option in which at least two sensors can be detected and checked for plausibility.

For this purpose, the present disclosure provides a monitoring device which can read two differential transformer sensors by two sensor interfaces and can monitor the measurement values detected by the differential transformer sensors.

Advantageous embodiments and developments can be found in the dependent claims and in the description with reference to the figures.

In a first embodiment, the monitoring device comprises a first conversion device which is arranged between the first sensor interface and the calculation apparatus, and is designed to detect first sensor signals which are detected by the first sensor interface, and to convert the signals into digital data, which correspond to the first measurement values, and to transmit the signals to the calculation apparatus. The monitoring device further comprises a second conversion device which is arranged between the second sensor interface and the calculation apparatus, and is designed to detect second sensor signals which are detected by the second sensor interface, and to convert the signals into digital data, which correspond to the second measurement values, and to transmit the signals to the calculation apparatus. As a result, the evaluation of the differential transformer sensors can be carried out very efficiently without straining the calculation apparatus.

In one embodiment, the first conversion device and/or the second conversion device comprises a characteristic curve memory which has a characteristic curve for at least one type of differential transformer sensor, which curve indicates the corresponding digital data for a predetermined sensor signal, the data corresponding to a path or an angle. This allows very fast and simple evaluation of the differential transformer sensors.

In one embodiment, the monitoring device comprises a first communication apparatus which is designed to wirelessly output the detected first measurement values and second measurement values. Furthermore, the display device comprises a second communication apparatus which is in wireless communication with the first communication apparatus and is designed to receive the wirelessly output first measurement values and second measurement values. This makes it possible to carry out the monitoring of the differential transformer sensors without direct physical contact with the sensors.

For example, an evaluation of the differential transformer sensors can be carried out from the cockpit of an aircraft, whilst for example the control stick is actuated.

In one embodiment, the monitoring device comprises a signal-processing apparatus which is designed to apply predetermined configurable signal-processing functions to the first measurement values and the second measurement values and output the calculation results. In addition to the parallel observation of the measurement values, this also allows calculations to be carried out on the basis of the detected measurement values.

In one embodiment, the predetermined configurable signal-processing functions comprise a subtraction and/or a summation and/or an integration and/or a differentiation and/or a transformation into the frequency range. This makes it possible to adapt the monitoring device according to the disclosure herein to different applications.

In one embodiment, the signal-processing apparatus has predetermined maximum limit values and/or minimum limit values for the predetermined configurable signal-processing functions and is designed to output an alarm signal when the result of one of the predetermined configurable signal-processing functions exceeds the corresponding maximum limit value or falls below the corresponding minimum limit value. As a result, for example a subtraction of two differential transformer sensors which are redundantly arranged on a control surface of an aircraft can be carried out, and an alarm output when the values thereof deviate too far from one another.

In one embodiment, the display device is designed to display the calculation results together with the detected first measurement values and the detected second measurement values or separately from the detected first measurement values and the detected second measurement values. This allows simple visual comparison of the calculation results and the detected first measurement values and the detected second measurement values.

In one embodiment, the monitoring device comprises an oscillator which is coupled with the first sensor interface and the second sensor interface and is designed to output a sinusoidal signal having a predetermined frequency and/or amplitude by the first sensor interface to a first differential transformer sensor which is coupled with the first sensor interface and by the second sensor interface to a second differential transformer sensor which is coupled with the second sensor interface. As a result, the differential transformer sensors can be controlled and operated directly via the monitoring device without additional control electronics being required.

In one embodiment, the monitoring device comprises a plurality of additional sensor interfaces which can be coupled with additional differential transformer sensors, wherein the calculation apparatus is coupled with the plurality of additional sensor interfaces and is designed to detect and output measurement values from the additional differential transformer sensors which are coupled with the plurality of sensor interfaces, wherein the display device is designed to display the detected additional measurement values separately or together. As a result, it is possible to monitor more than just two sensors at the same time.

The configurations and developments above can be combined with one another as desired where appropriate. Further possible configurations, developments and implementations of the disclosure herein include combinations of features of the disclosure herein described previously or in the following with respect to the embodiments, even if these combinations are not explicitly mentioned. In particular, in the process a person skilled in the art will also add individual aspects as improvements or additions to the respective basic form of the present disclosure.

### BRIEF DESCRIPTION OF THE DRAWINGS

The disclosure herein will be described in greater detail below on the basis of embodiments with reference to the accompanying figures of the drawings.

In the drawings:

FIG. 1 is a block diagram of an embodiment of the monitoring device according to the disclosure herein;

FIG. 2 is a flow chart of a method according to the disclosure herein; and

FIG. 3 is a block diagram of a further embodiment of the monitoring device according to the disclosure herein.

In the figures, the same reference numerals denote like or functionally like components, unless stated otherwise.

### DETAILED DESCRIPTION

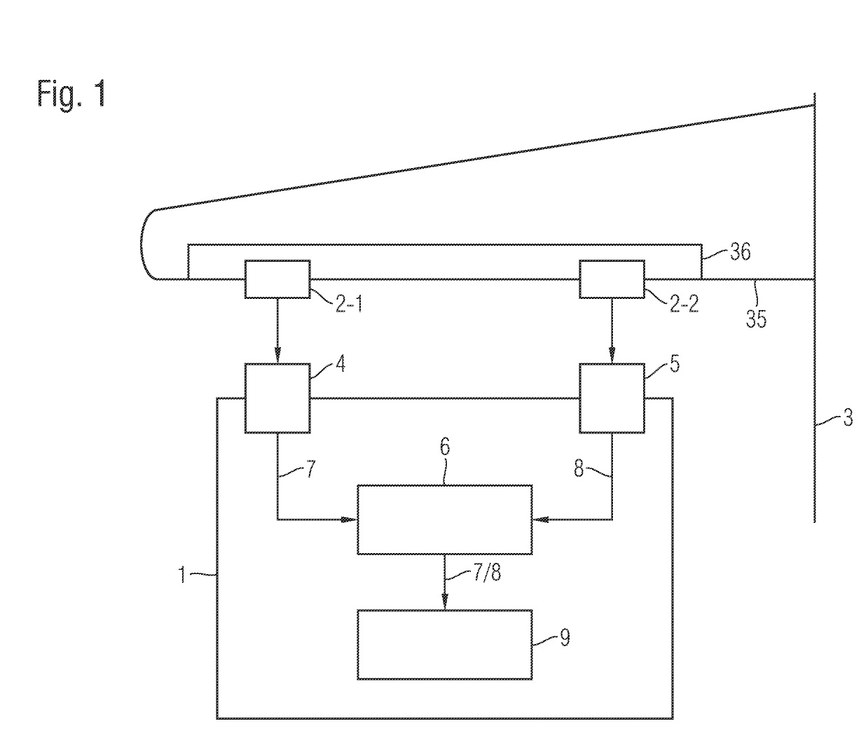

FIG. 1 is a block diagram of an embodiment of the monitoring device 1 according to the disclosure herein.

The monitoring device 1 in FIG. 1 is coupled with two differential transformer sensors 2-1, 2-2 which are arranged on an aileron 36 of a wing 35 of an aircraft 3.

The differential transformer sensors 2-1, 2-2 in FIG. 1 are arranged on the aileron 36 merely by way of example. In further embodiments, the differential transformer sensors 2-1, 2-2 can also be arranged on any other desired control surfaces of the aircraft 3. For example, the differential transformer sensors 2-1, 2-2 can also be arranged on a rudder or elevator on the tail of the aircraft 3.

In another variant, the differential transformer sensors 2-1, 2-2 can also be arranged on different control surfaces of the aircraft 3. For example, each of the differential transformer sensors 2-1, 2-2 can be arranged on an aileron on a side of the aircraft 3. As a result, it is possible for example to check whether the ailerons carry out a movement in the opposite direction when the control stick is actuated.

The monitoring device 1 comprises two sensor interfaces 4 and 5, of which the first sensor interface is coupled with the first differential transformer sensor 2-1. The second sensor interface 5 is coupled with the second differential transformer sensor 2-2.

In FIG. 1, the monitoring device 1 is arranged behind the wing of the aircraft 3. The direct coupling of the differential transformer sensors 2-1, 2-2 with the sensor interfaces 4, 5 is shown merely by way of example. In further embodiments, the coupling of the differential transformer sensors 2-1, 2-2 with the sensor interfaces 4, 5 can be carried out in multiple ways.

For example, the coupling of the differential transformer sensors 2-1, 2-2 with the sensor interfaces 4, 5 can be carried out via a digital data bus of the aircraft 3, discrete analogous lines or the like.

The sensor interfaces 4, 5 are coupled with a calculation apparatus 6, which detects first measurement values 7 from the first differential transformer sensor 2-1 by the first sensor interface 4 and detects second measurement values 8 from the second differential transformer sensor 2-2 by the second sensor interface 5.

The calculation apparatus 6 is further designed to combine the detected first measurement values 7 and the detected second measurement values 8 and to transmit the values to the display device 9.

The display device 9 is designed to display the transmitted first measurement values 7 and the transmitted second measurement values 8. In the process, the display device 9 can display the transmitted first measurement values 7 and the transmitted second measurement values 8 together, for example in a single diagram, or separately, for example in two separate diagrams.

In the context of this disclosure, a differential transformer sensor 2-1, 2-2 is to be understood to mean any sensor which is based on the transformer principle. For example, LVDT (linear variable differential transformer) or RVDT (rotary variable differential transformer) sensors can be used as differential transformer sensors.

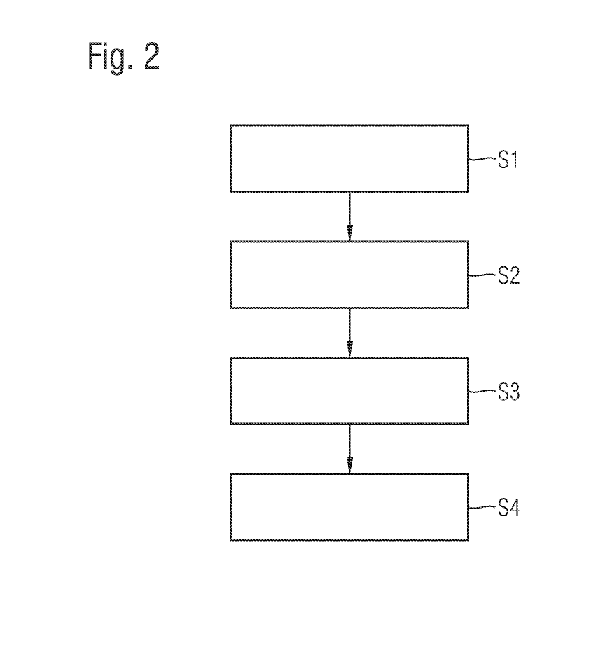

FIG. 2 is a flow chart of a method according to the disclosure herein.

The method according to the disclosure herein is provided for monitoring differential transformer sensors 2-1, 2-2 in an aircraft 3 and comprises:

Detecting S1 first measurement values 7 from a first differential transformer sensor 2-1. It is further provided to detect S2 second measurement values 8 from a second differential transformer sensor 2-2. The detected first measurement values 7 and the detected second measurement values 8 are output together, S3 by a first communication interface, and lastly displayed S4.

During the display S4, the detected first measurement values 7 and the detected second measurement values 8 can be displayed together, for example in the same diagram, or separately, for example in two diagrams shown one below the other.

For the simple detection and data processing of the detected first measurement values 7 and the detected second measurement values 8, in one embodiment, detected first sensor signals 15-1 and detected second sensor signals 15-2 can be converted into digital data 11-1, 11-2, which correspond to the first measurement values 7 and the second measurement values 8, before being output together.

In one embodiment, the conversion can comprise reading the digital data 11-1, 11-2, which correspond to a predetermined sensor signal 15-1, 15-2, from a characteristic curve memory 13.

For this purpose, the characteristic curve memory 13 has a characteristic curve 14 for the corresponding type of differential transformer sensor 2-1, 2-2, which curve indicates the corresponding digital data 11-1, 11-2 for a predetermined sensor signal 15-1, 15-2, which data correspond for example to a path to be measured or to an angle to be measured.

In one embodiment, the characteristic curve memory 13 can have a plurality of characteristic curves 14. In this case, each of the characteristic curves can be assigned for example to a predetermined type of differential transformer sensor 2-1, 2-2. However, the characteristic curves 14 can also be designed specifically for a predetermined aircraft 3. In such an embodiment, the characteristic curve memory 13 has a characteristic curve 14 for example for each control surface of the aircraft 3, which curve indicates which measurement value 7, 8 from the corresponding differential transformer sensor 2-1, 2-2 corresponds to which path or angle of the control surface. As a result, it is possible for example to show a model of the aircraft 3 and to display the actual deflection of the respective control surfaces in the display device 9.

In one embodiment, the detected first measurement values 7 and the detected second measurement values 8 are output wirelessly by a first communication interface 16. For example, the detected first measurement values 7 and the detected second measurement values 8 are transmitted by Bluetooth (R), WLAN, GSM, UMTS or the like and received and output by a display device 9 according to the disclosure herein.

In order to be able to carry out an extended signal analysis, in one embodiment of the method according the disclosure herein, it can be provided that predetermined configurable signal-processing functions 25 are applied to the first measurement values 7 and the second measurement values 8, and the calculation results 19 are output for example together with the first measurement values 7 and the second measurement values 8.

Different functions can be provided as predetermined configurable signal- processing functions 25. For example, a subtraction, a summation, an integration, a differentiation, a transformation into the frequency range or the like or a combination of any desired functions from the options mentioned can be provided.

During the display, the calculation results 19 can be displayed together with the detected first measurement values 7 and the detected second measurement values 8 or separately from the detected first measurement values 7 and the detected second measurement values 8.

For example, it can be provided that, when monitoring two redundant differential transformer sensors 2-1, 2-2 which are arranged on a control surface of the aircraft 3, a difference between the first measurement values 7 and the second measurement values 8 is calculated and output. As a result, it is possible for example to check whether the redundant differential transformer sensors 2-1, 2-2 output the same values.

Furthermore, maximum limit values 20 and minimum limit values 21 can be provided for the predetermined configurable signal-processing functions 25. For example, in the case of a subtraction, a maximum limit value 20 can be predetermined which indicates the maximum permissible deviation between the first measurement values 7 and the second measurement values 8. If this limit value is exceeded, for example an alarm signal 22 can be output.

In another embodiment of the method, in addition to the differential transformer sensors 2-1, 2-2, a plurality of additional differential transformer sensors can be read and monitored. In this case, the method variants described above for the two differential transformer sensors 2-1, 2-2 can also be applied to the plurality of additional differential transformer sensors.

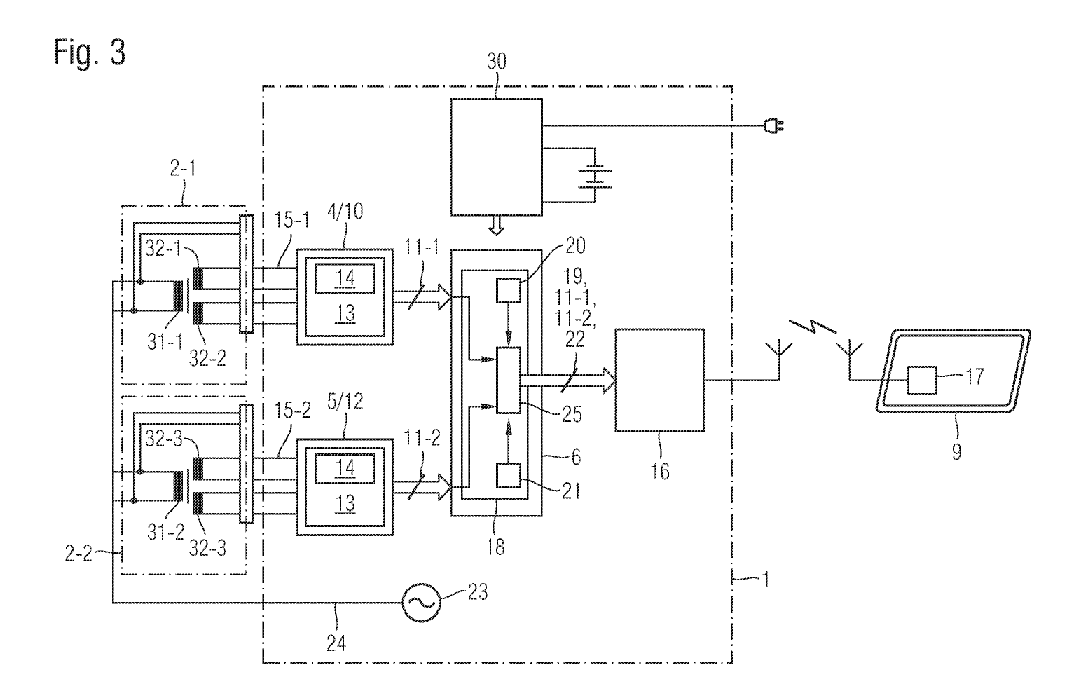

FIG. 3 is another block diagram of an embodiment of the monitoring device 1 according to the disclosure herein.

The monitoring device 1 in FIG. 3 comprises a first sensor interface 4, which is simultaneously designed as a conversion device 10. Furthermore, the second sensor interface 5 is designed as a second conversion device 12.

The first conversion device 10 and the second conversion device 12 are each designed to convert the sensor signals 15-1, 15-2 output by the differential transformer sensors 2-1, 2-2 into digital data 11-1, 11-2.

The differential transformer sensors 2-1, 2-2 each comprise an excitation coil 31-1, 31-2 and two secondary coils 32-1, 32-4. The secondary coils 32-1-32-2 are coupled with the first conversion device 10 or sensor interface 4 by two signal lines in each case. Furthermore, the secondary coils 32-3-32-4 are coupled with the second conversion device 12 or sensor interface 5 by two signal lines in each case.

As already noted above, the first sensor interface 4 and the second sensor interface 5 each comprise a characteristic curve memory 13, in which at least one characteristic curve 14 corresponding to the differential transformer sensors 2-1, 2-2 is stored. Alternatively, for example the first sensor interface 4 and the second sensor interface 5 can comprise configuration interfaces by which for example a zero point or a maximum and a minimum of a path or angle recorded by a differential transformer sensor 2-1, 2-2 can be set in the first sensor interface 4 and the second sensor interface 5.

Another alternative is the use of a demodulation method in the first sensor interface 4 and the second sensor interface 5 which generates digital data 11-1, 11-2 directly from the analogue input voltages at the first sensor interface 4 and the second sensor interface 5.

The combination of a first sensor interface 4 and a first conversion device 10, and of a second sensor interface 5 and a second conversion device 12 respectively can comprise for example an analogue-to-digital converter for converting the voltages received in analogue form by the secondary coils into digital values and to generate a digital value 11-1 or 11-2 directly for example from the two voltages represented by the digital values by the characteristic curve 14, which digital value corresponds to a path or angle detected by the respective differential transformer sensor 2-1, 2-2. After the analogue-to-digital conversion, for example also a correction or filtration can be carried out, for example in software.

The digital data 11-1-11-2 are received by the calculation apparatus 6 which, in the embodiment shown in FIG. 3, comprises a signal-processing apparatus 18. The signal-processing apparatus 18 can evaluate the digital data 11-1, 11-2 and apply predetermined configurable signal-processing functions 25 to the digital data 11-1, 11-2.

For example, the signal-processing apparatus 18 can calculate a difference between the paths or angles represented by the digital data 11-1 and 11-2 and output the calculation results 19 together with the digital data 11-1, 11-2.

In the signal-processing apparatus 18, a maximum limit value 20 and a minimum limit value 21 are additionally defined which predetermine a maximum or a minimum limit value for the calculation result 19. In the case of a subtraction, for example merely the maximum limit value 20 can be predetermined and a maximum permissible difference for the sensor signals 15-1, 15-2 output by the two differential transformer sensors 2-1, 2-2 can be indicated.

If the difference calculated by the signal-processing apparatus 18 exceeds the limit value, the signal-processing apparatus 18 can output for example an alarm signal 22.

In FIG. 3, the signal-processing apparatus 18 is arranged in the calculation apparatus 6. However, in further embodiments, the signal-processing apparatus 18 is not restricted to the calculation apparatus 6, but rather can also be arranged for example in the display device 9. In such an embodiment, the digital data 11-1, 11-2 are merely combined by the calculation apparatus 6 and prepared for transmission to the display device 9.

The calculation apparatus 6 in FIG. 3 is coupled with a first communication apparatus 16 which is in the form of a wireless communication apparatus 16. For example, the communication apparatus 16 can transmit data wirelessly by Bluetooth (R), WLAN, GSM, UMTS, ZigBee or the like. Accordingly, the display device 9 comprises a second communication apparatus 17 which receives and displays wirelessly transmitted data.

The monitoring device 1 further comprises an oscillator 23 which is designed to output an appropriate control signal, for example a sinusoidal signal 24 or a sinusoidal voltage 24, for the excitation coils 31-1, 31-2 of the two differential transformer sensors 2-1, 2-2.

For example, the oscillator 23 can output a sinusoidal voltage having an amplitude of up to 10 V, in particular of 7 V, and a frequency of between 1000 Hz and 2000 Hz, in particular 1953 Hz.

Accordingly, the first sensor interface 4 and the second sensor interface 5 can be designed for example to receive and digitise a sinusoidal voltage having an amplitude of up to 10 V, in particular of 7 V or 6 V, and having a frequency of from 1000 Hz to 2000 Hz, in particular 1953 Hz.

However, the oscillator 23 can also be adjusted for example by suitable wiring, such as an amplification, to an output amplitude of 28 V or a frequency of 400 Hz. The first sensor interface 4 and the second sensor interface 5 can be adapted to the respective oscillators 23 by suitable corresponding external wiring.

Because it is necessary to sample a signal with double the maximum relevant frequency in order to be able to reconstruct the signal, the first sensor interface 4 and the second sensor interface 5 for example can be designed to sample signals having a frequency of up to 4000 Hz.

However, in further embodiments, the oscillator 23, the first sensor interface 4 and the second sensor interface 5 are not restricted to frequencies of up to 4000 Hz or 2000 Hz. Rather, any desired higher frequencies which correspond to the sensors used in each case are possible.

In the monitoring device 1, lastly an energy source 30 is provided which supplies the additional components of the monitoring device 1 with electrical energy. The energy source 30 can be for example a DC-to-DC converter or what is known as a buck-boost converter or the like. In FIG. 3, it is shown that the energy source 30 can be powered either from for example an on-board network of the aircraft 3 via a plug or from a battery. In particular when the energy source 30 is powered by a battery, the monitoring device 1 can be used very flexibly in different locations in the aircraft 3.

Although the present disclosure has been described on the basis of preferred embodiments, it is not restricted to the embodiments, but rather can be modified in various ways.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A monitoring device for differential transformer sensors in an aircraft, comprising:
a first sensor interface for coupling with a first differential transformer sensor;
a second sensor interface for coupling with a second differential transformer sensor;
a calculation apparatus which is coupled with the first sensor interface and the second sensor interface and is designed to detect and output first measurement values from a first differential transformer sensor which is coupled with the first sensor interface and second measurement values from a second differential transformer sensor which is coupled with the second sensor interface; and
a display device which is designed to display the detected first measurement values and the detected second measurement values separately or together.

2. The monitoring device according to claim 1, comprising a first conversion device which is arranged between the first sensor interface and the calculation apparatus and is designed to detect detected first sensor signals by the first sensor interface and convert the signals into first digital data, which correspond to the first measurement values, and transmit the signals to the calculation apparatus, and a second conversion device which is arranged between the second sensor interface and the calculation apparatus and is designed to detect detected second sensor signals by the second sensor interface and convert the signals into second digital data, which correspond to the second measurement values, and transmit the signals to the calculation apparatus.

3. The monitoring device according to claim 2, wherein the first conversion device and/or the second conversion device comprises a characteristic curve memory which has a characteristic curve for at least one type of differential transformer sensor, which curve indicates the corresponding digital data for a predetermined sensor signal, the data corresponding to a path or an angle.

4. The monitoring device according to claim 1, comprising a first communication apparatus which is designed to wirelessly output the detected first measurement values and second measurement values, wherein the display device comprises a second communication apparatus which is in wireless communication with the first communication apparatus and is designed to receive the wirelessly output first measurement values and second measurement values.

5. The monitoring device according to claim 1, comprising a signal-processing apparatus which is designed to apply predetermined configurable signal-processing functions to the first measurement values and the second measurement values and output the calculation results.

6. The monitoring device according to claim 5, wherein the predetermined configurable signal-processing functions comprise a subtraction and/or a summation and/or an integration and/or a differentiation and/or a transformation into the frequency range, and wherein the signal-processing apparatus has in particular predetermined maximum limit values and/or minimum limit values for the predetermined configurable signal-processing functions and is designed to output an alarm signal when the result of one of the predetermined configurable signal-processing functions exceeds the corresponding maximum limit value or falls below the corresponding minimum limit value.

7. The monitoring device according to claim 5, wherein the display device is designed to display the calculation results together with the detected first measurement values and the detected second measurement values or separately from the detected first measurement values and the detected second measurement values.

8. The monitoring device according to claim 1, comprising an oscillator which is coupled with the first sensor interface and the second sensor interface and is designed to output a sinusoidal signal having a predetermined frequency and/or amplitude by the first sensor interface to a first differential transformer sensor which is coupled with the first sensor interface and by the second sensor interface to a second differential transformer sensor which is coupled with the second sensor interface.

9. The monitoring device according to claim 1, comprising a plurality of additional sensor interfaces which can be coupled with additional differential transformer sensors; wherein the calculation apparatus is coupled with the plurality of additional sensor interfaces and is designed to detect and output measurement values from the additional differential transformer sensors which are coupled with the plurality of sensor interfaces, and wherein the display device is designed to display the detected additional measurement values separately or together.

10. A method for monitoring differential transformer sensors in an aircraft, comprising:
detecting first measurement values from a first differential transformer sensor;
detecting second measurement values from a second differential transformer sensor;
outputting the detected first measurement values and the detected second measurement values together by a first communication interface; and
displaying the detected first measurement values and detected second measurement values which are output together by the first communication interface.

11. The method according to claim 10, comprising converting detected first sensor signals and detected second sensor signals into digital data, which correspond to the first measurement values and the second measurement values, before outputting the signals together.

12. The method according to claim 10, wherein the conversion comprises reading digital data, which correspond to a predetermined sensor signal, from a characteristic curve memory which has a characteristic curve for at least one type of differential transformer sensor, which curve indicates the corresponding digital data for a predetermined sensor signal, the data corresponding to a path or an angle.

13. The method according to claim 10, wherein the output by the first communication interface takes place wirelessly.

14. The method according to claim 10, comprising applying predetermined configurable signal-processing functions to the first measurement values and the second measurement values and outputting the calculation results.

15. The method according to claim 14, wherein the predetermined configurable signal-processing functions comprise a subtraction and/or a summation and/or an integration and/or a differentiation and/or a transformation into the frequency range; and/or wherein during the display, the calculation results are displayed together with the detected first measurement values and the detected second measurement values or separately from the detected first measurement values and the detected second measurement values.
